(19) United States
(12) Patent Application Publication
(10) Pub. No.: US 2011/0291002 A1
(43) Pub. Date: Dec. 1, 2011

(54) GAS ANALYZER

(75) Inventor: Kouhei SASAI, Kyoto-shi (JP)

(73) Assignee: HORIBA STEC, CO., LTD., Kyoto (JP)

(21) Appl. No.: 13/113,404

(22) Filed: May 23, 2011

(30) Foreign Application Priority Data
May 27, 2010 (JP) 2010-122122

(51) Int. Cl. H01J 49/26

(52) U.S. Cl. 250/288

(57) ABSTRACT

This invention is to high-pressurize the maximum pressure for use of a gas analyzer, and comprises an ionizing part having an opening part to lead out ions of a sample gas to the outside, an ion drawing electrode arranged outside of the opening part of the ionizing part, a quadrupole part that selectively passes the ions lead out to the outside by the ion drawing electrode, and an ion detecting part that detects the ions passing the quadrupole, and an opening size of the opening part of the ionizing part is set to be smaller than an imaginary inscribing circle inscribed on all of four pole electrodes constituting the quadrupole part.

### FIELD OF THE ART

This invention relates to a gas analyzer using a quadrupole mass spectrometry.

### BACKGROUND ART

As this kind of the gas analyzer as shown in a patent document 1 or a non-patent document 1, there is a gas analyzer comprising a sensor unit having an ionizing part, a quadrupole part, an ion detecting part and an alternating current generating part and a body connected to the sensor unit through a cable.

This kind of the gas analyzer ionizes the residual gas introduced into the ionizing part by means of a thermal electron emitted by a high temperature filament. The produced ions are accelerated and converged by an ion drawing electrode and then introduced into the quadrupole part. In the quadrupole part, a direct current and an alternating current are applied to, for example, four cylindrical electrodes so that the ions are shifted. The shifted ions are detected as an electric current by a Faraday cup in the ion detecting part. Since this ionic current varies in accordance with an amount (a partial pressure) of the residual gas, it is possible to measure the residual gas with high accuracy.

However, there is a problem for the ionic current of this gas analyzer, if the ambient pressure where the quadrupole parts are arranged becomes high, it is difficult for the ions to reach the ion detecting part because the provability of colliding the ions with the gaseous body flying in the quadrupole parts becomes high and the detection sensitivity changes due to an influence of the space electric charge. Then, if the ambient pressure becomes higher than a predetermined value (for example, about 1×10⁻²˜1×10⁻¹ Pa), the increase of the ionic current becomes dull. And if the ionic current exceeds a peak value, it begins to decrease (refer to FIG. 12). The ambient pressure indicating the peak value is the maximum pressure for use.

If the gas analyzer is used in an area where the measured value stops increasing in proportion to the change of the ambient pressure, there is a problem that it fails to obtain the accurate measurement value. In addition, recently it becomes a mainstream to conduct a semiconductor process under a pressure (for example 1.2 Pa) bigger than the maximum pressure for use (about 1 Pa) of the gas analyzer. Then, since the gas analyzer is used under a pressure approximate to or bigger than its maximum pressure for use, there is a problem that it is difficult to conduct the semiconductor process accurately. Although it can be conceived that the measurement value is corrected in order to cope with this situation, it cannot be an ultimate solution and there is still a problem that the measurement value fluctuates due to the accuracy of the correction.

### PRIOR ART DOCUMENT

Patent Document
Japanese Unexamined Patent Application Publication No. 8-510084

Non-Patent Document
“Micromini Residual Gas Analyzer, Pressure Master RGA series” HORIBA Technical Reports, Horiba Ltd., March, 2004, Number 28, p12˜p15, written by IKEDA Toru

### DISCLOSURE OF THE INVENTION

### Problems to be Solved by the Invention

As a result of the keen examination by the present claimed inventor whether or not the maximum pressure for use can be high-pressurized by reviewing the structure of the gas analyzer, a correlation between the sensitivity of the ion detecting part and the maximum pressure for use shown in FIG. 4 was obtained by an experiment. Then the present claimed inventor first found that the maximum pressure for use increased if the signal value (sensitivity) of the ion detecting part was made to be smaller by decreasing the amount of the ions introduced into the quadrupole parts as shown in FIG. 4.

In order to solve all of the problems the present claimed invention was first embodied by making use of a relationship between the amount of the ions introduced into the quadrupole part and the maximum pressure for use, and a main object of this invention is to high-pressurize the maximum pressure for use.

### Means to Solve the Problems

Specifically, the gas analyzer in accordance with this invention is mounted on a vacuum chamber and analyzes a sample gas in the vacuum chamber, and comprises an ionizing part that ionizes the sample gas and that has an ion lead-out opening to lead out ions to the outside, an ion drawing electrode that is arranged outside of the ion lead-out opening of the ionizing part and that derives the ions, a quadrupole part that selectively passes the ions lead out from the ionizing part by the ion drawing electrode, and an ion detecting part that detects the ions passing the quadrupole part, and is characterized by that the ionizing part, the ion drawing electrode, the quadrupole part and the ion detecting part are arranged so as to be exposed to an ambient pressure in the vacuum chamber, and an opening size of the ion lead-out opening is set to be smaller than an imaginary circle inscribed on all of four pole electrodes constituting the quadrupole part in order to raise the maximum pressure for use showing the ambient pressure where a signal value obtained by the ion detecting part becomes a peak value.

In accordance with this arrangement, the amount of the ions introduced into the quadrupole part decreases by setting the opening size of the ion lead-out opening to be smaller than the imaginary inscribing circle inscribed on all of four pole electrodes constituting the quadrupole part, and then the signal value obtained by the ion detecting part becomes small. As a result of this, it is possible to high-pressurize the maximum pressure for use. Concretely, the maximum pressure for use can be raided to a low vacuum area. The reason why the maximum pressure for use can be raised to the low vacuum area by lessening the opening size of the ion lead-out opening is based on the correlation between the sensitivity of the ion detecting part and the maximum pressure for use as shown in FIG. 4. In addition, since the opening size of the ion lead-out opening is smaller than the imaginary inscribing circle, the ions coming out from the ion lead-out opening can be easily introduced into the quadrupole part. As a result, even though the ion amount itself coming out from the ion lead-out opening decreases, it is possible to effectively make use of the ions. Furthermore, since the ionizing part, the ion drawing electrode, the quadrupole part and the ion detecting part are arranged so as to be exposed to the ambient pressure in the vacuum chamber, there is no need of a differential exhaust mechanism so that it is possible to make the gas analyzer compact.

It is preferable that the ion drawing electrode has an opening part through which the ions pass, and an opening size of the opening part is set to be smaller than the imaginary inscribing circle and furthermore smaller than an opening size of the ion lead-out opening. As mentioned above, since the ionic current becomes small by reducing the ion lead-out opening, there is a problem that a base line of a signal obtained by the ion detecting part is lowered. The lowering of the base line is considered to be caused by electrons that are introduced into the quadrupole similar to the ions. As mentioned, it is possible to lessen the amount of the electron introduced into the quadrupole as much as possible by reducing the opening part of the ion drawing electrode, and the base line can be improved.

Since the ions introduced into the quadrupole are limited by the ion lead-out opening, it is necessary to introduce the ions as much as possible within the limited range from a view point of improving an SN ratio. In order to make it possible to introduce the ions generated in the ionizing part into the ion lead-out opening efficiently, it is preferable that the ionizing part has an unequipotential reducing structure that reduces an unequipotential area generating near a gas introducing part of the ionizing part by means of a peripheral member of a ground potential arranged outside of the ionizing part.

### Effect of the Invention

In accordance with this invention having the above arrangement, it is possible to high-pressurize the maximum pressure for use without relying on the correction calculation.

### BRIEF DESCRIPTION OF THE DRAWINGS

FIG. 1 is a pattern configuration diagram of a gas analyzer in accordance with one embodiment of this invention.

FIG. 2 is an internal configuration diagram of a sensor part of this embodiment.

FIG. 3 is a view to show a positional relation between a pole electrode, an ion lead-out opening and an opening part in this embodiment.

FIG. 4 is a view to show a correlation between a sensitivity of the ion detecting part and the maximum pressure for use.

FIG. 5 is a view to show a relation between an opening diameter of an ion drawing opening and the maximum pressure for use.

FIG. 6 is a view to show a relation between an opening diameter of an opening part of the ion drawing electrode and the maximum pressure for use.

FIG. 7 is a view to show a comparison between the maximum pressure for use of a conventional gas analyzer and the maximum pressure for use of the gas analyzer of this embodiment.

FIG. 8 is a view to show a comparison between the minimum pressure for use of the conventional gas analyzer and the minimum pressure for use of the gas analyzer of this embodiment.

FIG. 9 is a view to show a base line voltage in case of varying an opening diameter of the opening part.

FIG. 10(A) is a view to show a potential in an ionizing part.

FIG. 10(B) is a view to show a potential in an ionizing part.

FIG. 11 is a view to show an SN ratio with or without the unequipotential reducing structure.

FIG. 12 is a view to show a measurement result of the conventional gas analyzer.

### BEST MODES OF EMBODYING THE INVENTION

An embodiment of a gas analyzer in accordance with this invention will be explained with reference to drawings.

### <Configuration>

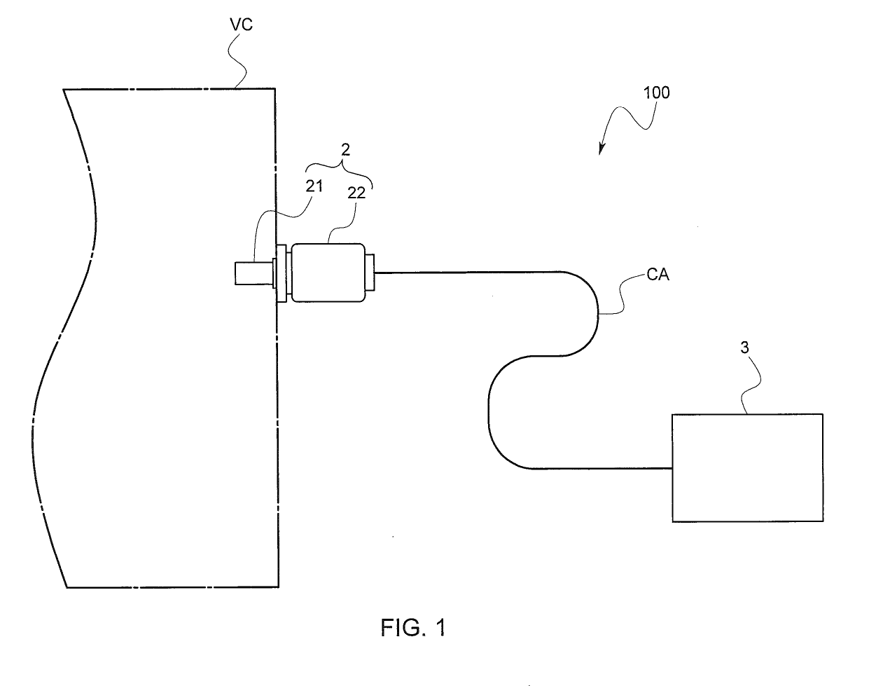

The gas analyzer 100 in accordance with this embodiment is used for monitoring a gas in a vacuum chamber (VC) during a semiconductor manufacturing process or after a semiconductor manufacturing device is cleaned, as shown in FIG. 1, and is mounted on the vacuum chamber (VC) and analyzes a residual gas as being a sample gas in the vacuum chamber (VC). Concretely, the gas analyzer 100 comprises a sensor unit 2 having a sensor part 21 that detects the sample gas such as a process gas or a residual gas in the vacuum chamber (VC), and a calculating part 22 that conducts an analyzing process of the residual gas based on an output of the sensor part 21. A code 3 is a power supply to supply electric power to the sensor unit 2.

The sensor unit 2 will be explained.

The sensor unit 2 comprises, as shown in FIG. 1, the sensor part 21 and the calculating part 22 that has a function as an alternative current generating device part arranged at a rear end part of the sensor part 21.

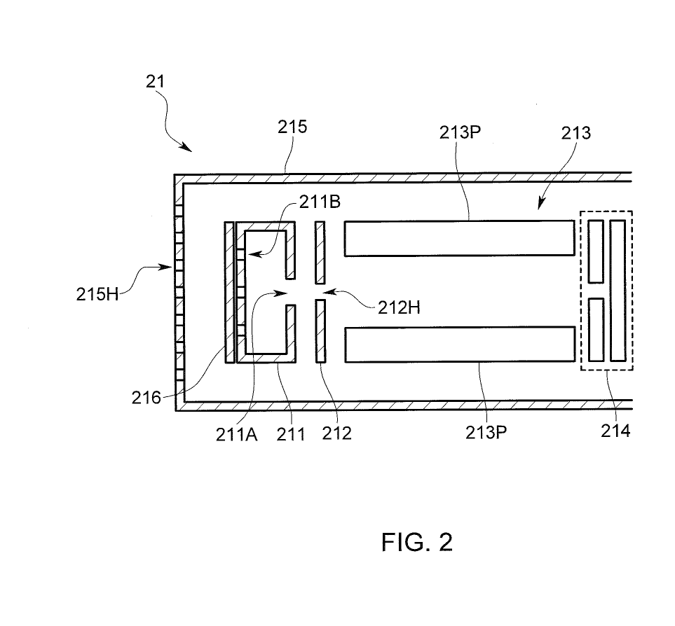

The sensor part 21 ionizes the residual gas as being the sample gas, and as shown in FIG. 2, comprises a ionizing part 211 having an ion lead-out opening 211A to lead out the ions to the outside, an ion drawing electrode 212 that is arranged outside of the ion lead-out opening 211A of the ionizing part 211 and that derives the ions, a quadrupole part 213 that selectively passes the ions derived from the ionizing part 211 by the ion drawing electrode 212 and an ion detecting part 214 that detects the ions passing the quadrupole part 213. The sensor part 21 comprises a protection cover 215 to house the ionizing part 211, the ion drawing electrode 212, the quadrupole part 213 and the ion detecting part 214 in this order from a distal end side and to protect them. The ionizing part 211, the ion drawing electrode 212, the quadrupole part 213 and the ion detecting part 214 are arranged on a straight line in the protection cover 215. A gas introduction opening 215H is arranged on a distal end wall of the protection cover 215 to introduce the residual gas in the vacuum chamber (VC) into the sensor part 21 in case of being mounted on the vacuum chamber (VC). The protection cover 215 is air-tightly mounted through a seal member or the like on a mounting bore (not shown in drawings) arranged on the vacuum chamber (VC). With this arrangement, the pressure in the protection cover 215 becomes the same as an ambient pressure in the vacuum chamber (VC) through the gas introduction opening 215H so that the ionizing part 211, the ion drawing electrode 212, the quadrupole part 213 and the ion detecting part 214 are exposed to the ambient pressure in the vacuum chamber (VC).

The ionizing part 211 comprises a filament in its inside and ionizes the sample gas by a thermal electron emitted from the filament. The ions generated by the ionizing part 211 are lead out to the outside by the ion drawing electrode 212 from the ion lead-out opening 211A whose shape is generally circle.

The ion drawing electrode 212 comprises a single or a plurality of electrodes. The ion drawing electrode 212 is arranged between the ionizing part 211 and the quadrupole part 213, and draws the ions generated by the ionizing part 211 to a side of the quadrupole part 213 and the ion detecting part 214 and accelerates • converges the ions.

The quadrupole part 213 separates an ion beam accelerated • converged by the ion drawing electrode 212 based on a ratio of the ion charge to the ion mass. Concretely, the quadrupole part 213 comprises two pairs of mutually facing electrodes (the pole electrodes 213P) each of which is arranged at 90° interval, and mutually facing pole electrodes 213P are set to be equipotential and a voltage wherein a direct voltage (U) and a high-frequency voltage (V cos ωt) are superimposed is applied to each pair, a UN ratio is made constant, and only V is varied so as to selectively pass the ions incoming into the mutually facing pole electrodes 213P in accordance with a mass/number of charge ratio.

The ion detecting part 214 is the Faraday cup that captures the ions separated by the quadrupole part 213 and detects the ions as an ionic current. Concretely, the ion detecting part 214 detects the ions of a specific component separated by the quadrupole part 213 so as to detect an absolute value of a partial pressure of the specified component in the sample gas. In addition, the ion detecting part 214 also detects all ions in the sample gas ionized by the ionizing part 211 so as to detect an absolute value of the total pressure of the sample gas.

As mentioned, the calculating part 22 has a calculation processing function and a control function, and further has a function as an alternate current generator. Namely, the calculating part 22 transfers the ionic current detected by the ion detecting part 212 into a digital voltage signal indicating a voltage value and outputs the voltage signal.

The calculating part 22 incorporates a circuit part (not shown in drawings) loaded with a CPU and an internal memory or the like and operates the CPU and its peripheral devices based on programs stored in the internal memory. Then, a calculation unit 3 analyzes and processes the sample gas based on the output from the sensor part 21.

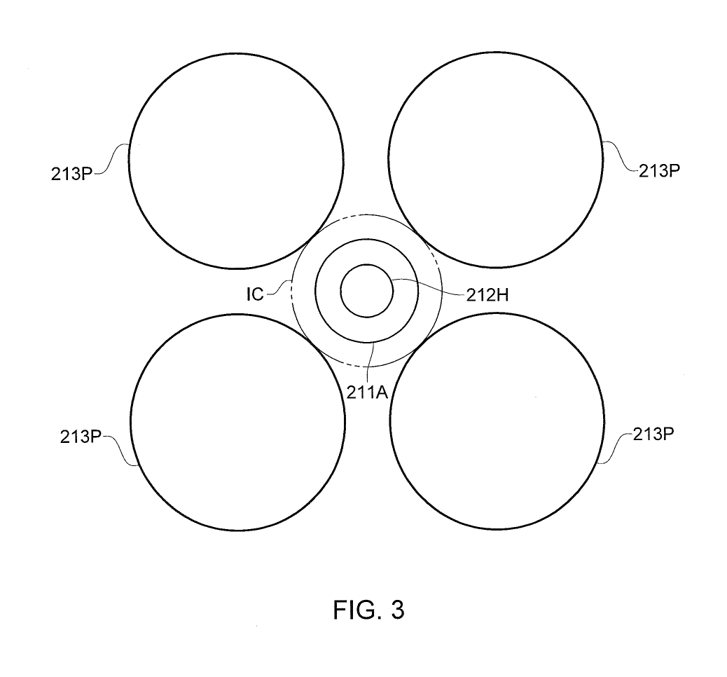

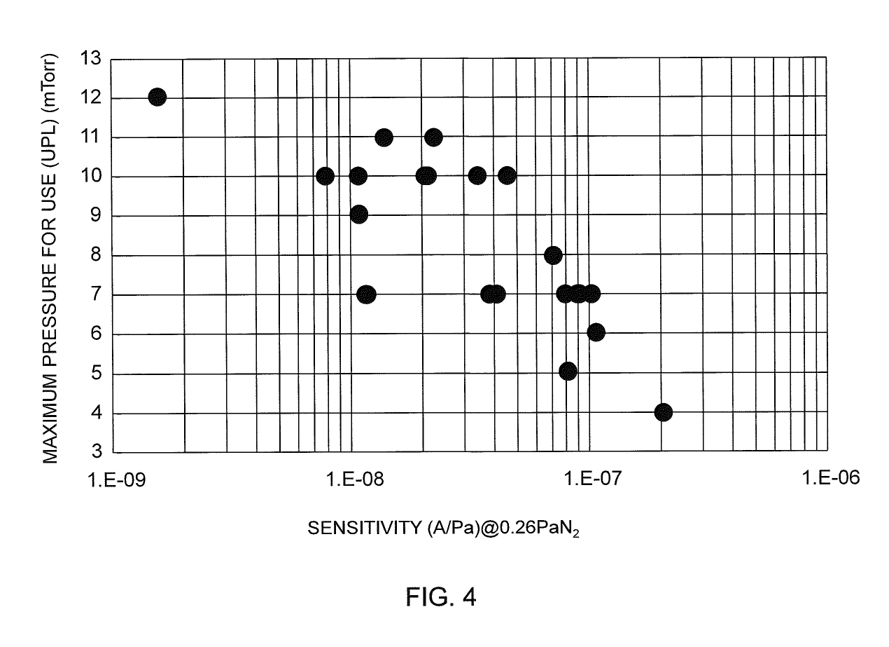

For the gas analyzer 100 of this embodiment, as shown in FIG. 3, an opening size of the ion lead-out opening 211A is set to be smaller than an imaginary inscribing circle (IC) (0.886 mm in this embodiment) inscribed on all of four pole electrodes 213P constituting the quadrupole part 213 in order to raise the maximum pressure for use (refer to FIG. 12) indicating the ambient pressure where the signal value obtained by the ion detecting part 211 becomes a peak value. The arrangement wherein the opening size of the ion lead-out opening 211A is set smaller than the imaginary inscribing circle (IC) is attributed to that a correlation between the sensitivity of the ion detecting part 211 and the maximum pressure for use is found as shown in FIG. 4. Concretely, the opening diameter (diameter) of the ion lead-out opening 211A is set to be 90% or less of the diameter (0.886 mm) of the imaginary inscribing circle (IC). Since it is not possible to obtain a sufficient resolution because the sensitivity becomes too small if the opening diameter of the ion lead-out opening 221A is set to be too small, it can be conceived the opening diameter of the ion lead-out opening 221A is set to be 30% or more of the imaginary inscribing circle (IC).

In addition, an opening size of an opening part 212H of the ion drawing electrode 212 is set to be both smaller than the imaginary inscribing circle (IC) and smaller than the opening size of the ion lead-out opening 211A. Concretely, the opening diameter of the opening part 212H of the ion drawing electrode 212 is set to be, for example, 70% or less of the diameter of the imaginary inscribing circle (IC).

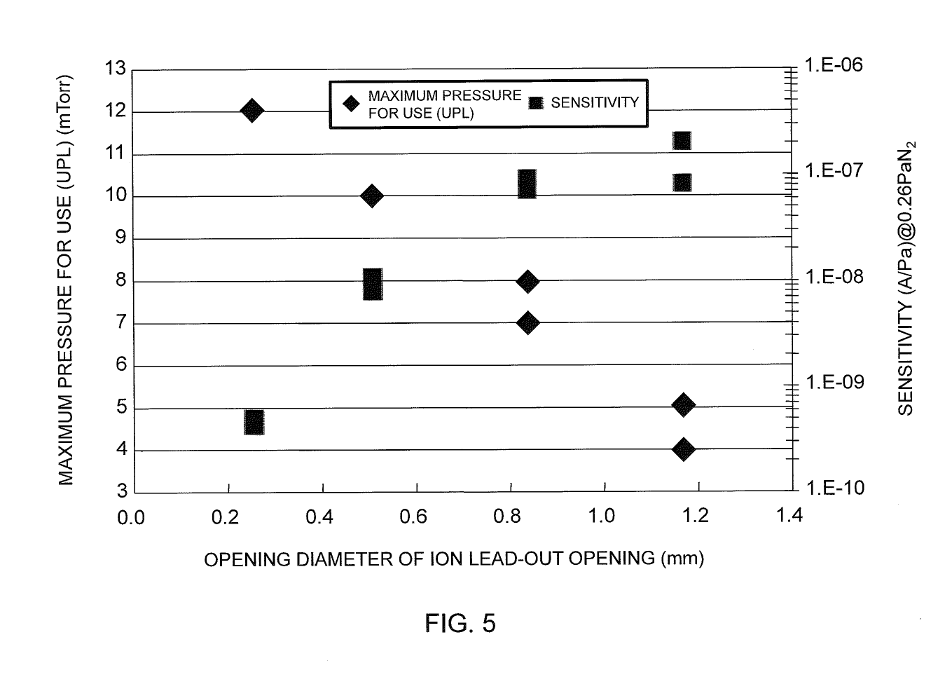

Next, in case that the opening diameter of the opening part 212H of the ion drawing electrode 212 is fixed at a certain amount (0.8 mm) and the opening diameter of the ion lead-out opening 211A of the ionizing part 211 is varied, the maximum pressure for use (UPL) and the sensitivity are shown in FIG. 5. As shown in FIG. 5, if the opening diameter of the ion lead-out opening 211A of the ionizing part 211 is gradually set to be smaller, it is proved that the sensitivity gradually drops and the maximum pressure for use (UPL) gradually increases.

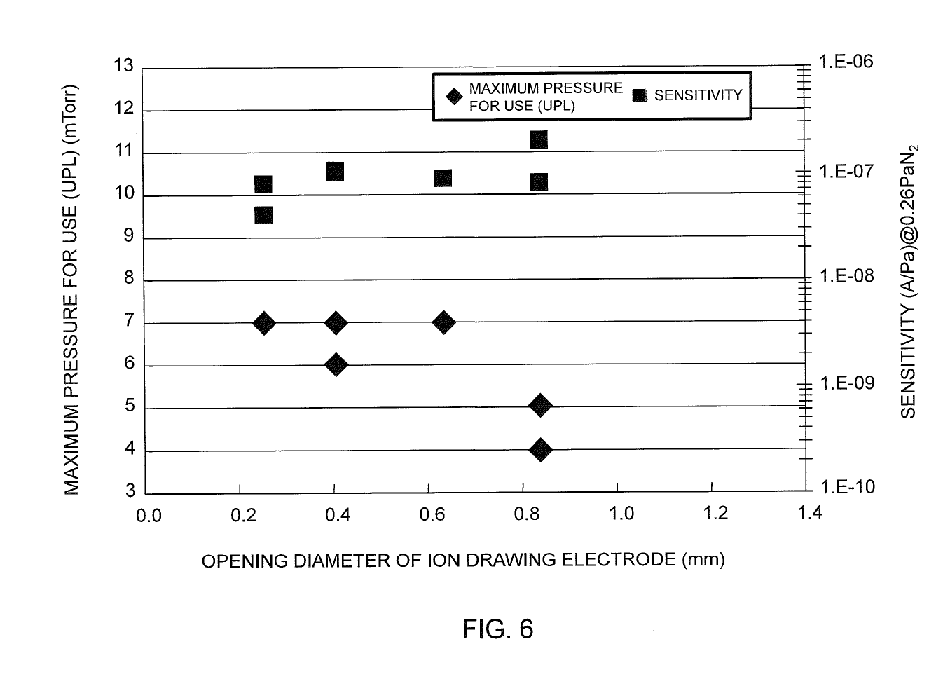

FIG. 6 shows the maximum pressure for use (UPL) and the sensitivity in case that the opening diameter of the ion lead-out opening 211A of the ionizing part 211 is fixed at a certain amount (1.2 mm) and the opening diameter of the opening part 212H of the ion drawing electrode 212 is varied. As shown in FIG. 6, the maximum pressure for use is not high-pressurized even though the opening diameter of the ion lead-out opening 211A of the ionizing part 211 is fixed and the opening diameter of the opening part 212H of the ion drawing electrode 212 is set to be small. Namely, it is proved that high-pressurization of the maximum pressure for use of the gas analyzer 100 is attributed to the opening diameter of the ion lead-out opening 211A of the ionizing part 211.

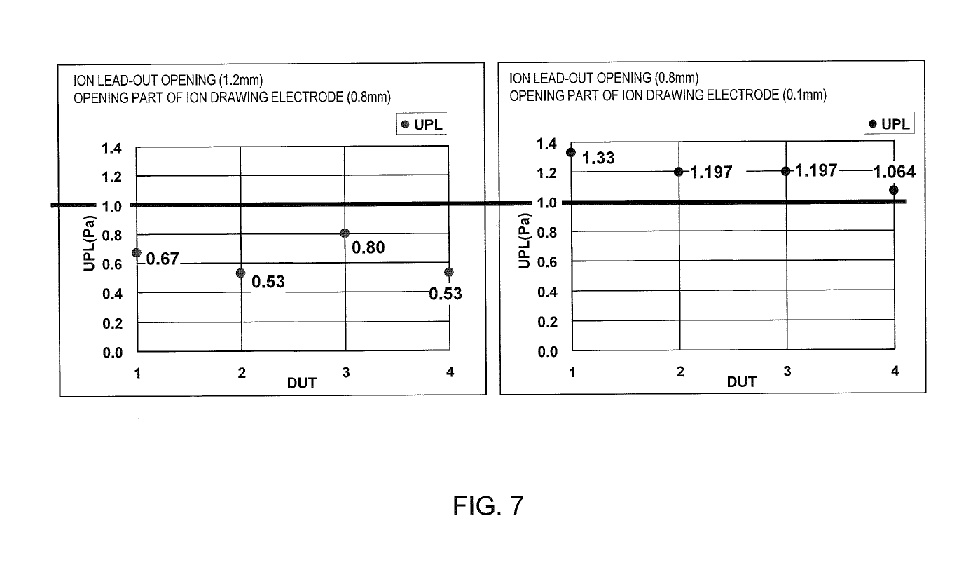

In addition, a comparison between the maximum pressure for use of a conventional gas analyzer wherein the opening diameter of the ion lead-out opening 211A is 1.2 mm (bigger than the diameter of the imaginary inscribing circle (IC)) and the opening diameter of the opening part 212H is 0.8 mm and the maximum pressure for use of the gas analyzer 100 of this embodiment wherein the opening diameter of the ion lead-out opening 211A is 0.8 mm (smaller than the diameter of the imaginary inscribing circle (IC)) and the opening diameter of the opening part 212H is 0.1 mm is shown in FIG. 7. As is clear from FIG. 7, the maximum pressure for use is about 0.5 Pa˜0.8 Pa for the conventional gas analyzer and the maximum pressure for use is about 1.0 Pa˜1.3 Pa for the gas analyzer 100 of this embodiment. As mentioned, in accordance with the gas analyzer 100 of this embodiment, it is possible to high-pressurize the maximum pressure for use.

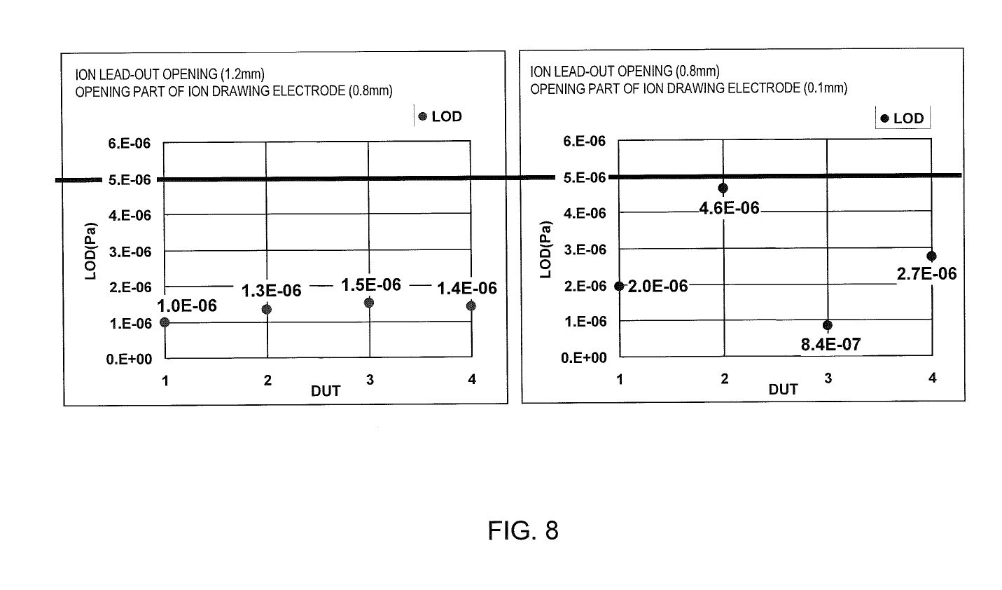

FIG. 8 shows a minimum pressure for use (LOD) as being the minimum ambient pressure that can be measured by the use of the gas analyzer. The minimum pressure for use of the conventional gas analyzer is 1.0×10⁻⁶ Pa˜1.5×10⁻⁶ Pa, and the minimum pressure for use of the gas analyzer 100 of this embodiment is 8.4×10⁻⁷ Pa˜5.0×10⁻⁶ Pa. As mentioned, even though the maximum pressure for use is high-pressurized by making the opening diameter of the gas lead-out opening 211A small, the gas analyzer can be used also in an area of high vacuum (for example, 5.0×10⁻⁶ Pa) similar to the conventional gas analyzer.

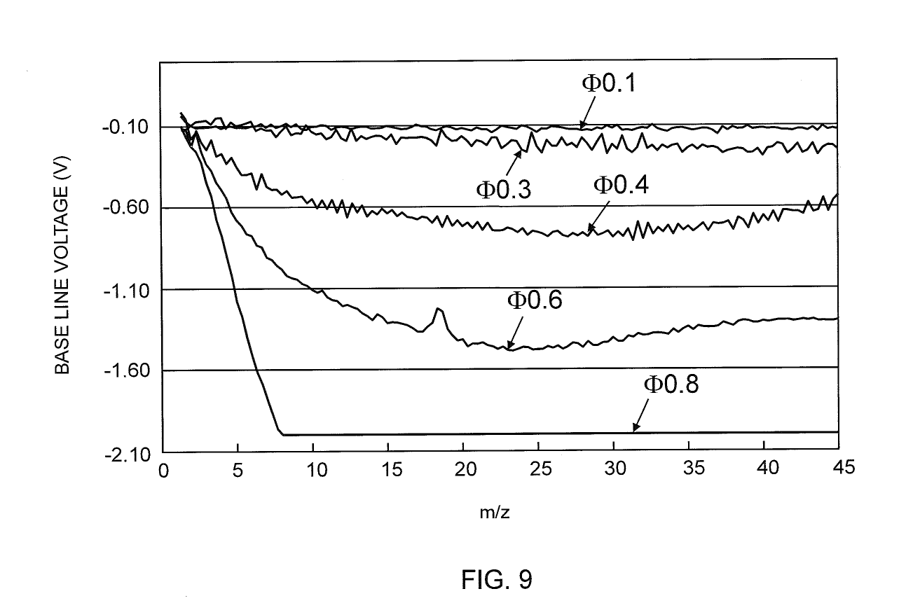

Next, an effect of the opening diameter of the opening part 212H of the ion drawing electrode 212 on a base line voltage to be a background signal of detecting the ions will be explained with reference to FIG. 9.

FIG. 9 shows the base line voltage in case that the diameter of the ion lead-out opening 211A is fixed to 0.8 mm and the opening diameter (diameter) of the opening part 212H is set to be 0.8 mm, 0.6 mm, 0.4 mm, 0.3 mm and 0.1 mm. As is clear from FIG. 9, the smaller the opening diameter of the opening part 212H, the more likely the base line voltage becomes constant irrespective of mass/number of electric charge (m/z). Based on FIG. 9, the opening diameter of the opening part 212H is preferably 0.1 mm˜0.3 mm, and most preferably 0.1 mm. A reason why the base line voltage becomes more stable when the opening diameter of the opening part 212H is smaller is considered to be that an amount of the electron introduced into the quadrupole part 213 can be reduced as much as possible so that the effect on the base line voltage of the electron also can be reduced as much as possible.

Furthermore, for the gas analyzer 100 of this embodiment, as shown in FIG. 2, the ionizing part 211 has an unequipotential reducing structure 216 that reduces an unequipotential area produced near a gas introducing part 211B arranged on the ionizing part 211 by means of a peripheral member (a protection cover 215) having the ground electric potential arranged outside of the ionizing part 211.

A structure to close up the gas introduction part 211B as being the unequipotential reducing structure 216 is a structure to cover whole of the gas introduction part 211B of the ionizing part 211. The structure is formed by a closing plate 216 and a voltage (for example, 70V) that is the same as that of the casing of the ionizing part 211 is applied to the closing plate 216. With this arrangement, the unequipotential area that is produced near the gas introduction part 211B formed on the casing of the ionizing part 211 is eliminated so that it is possible to prevent the ions generating in the ionizing part 211 from stagnating in the unequipotential area or from going out from the gas introduction part 211B through the unequipotential area.

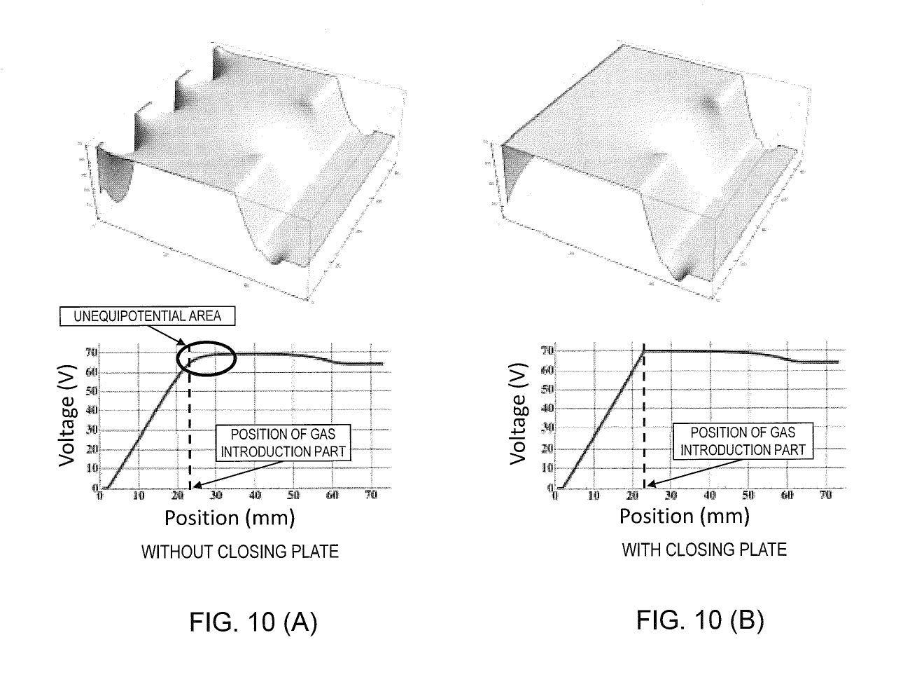

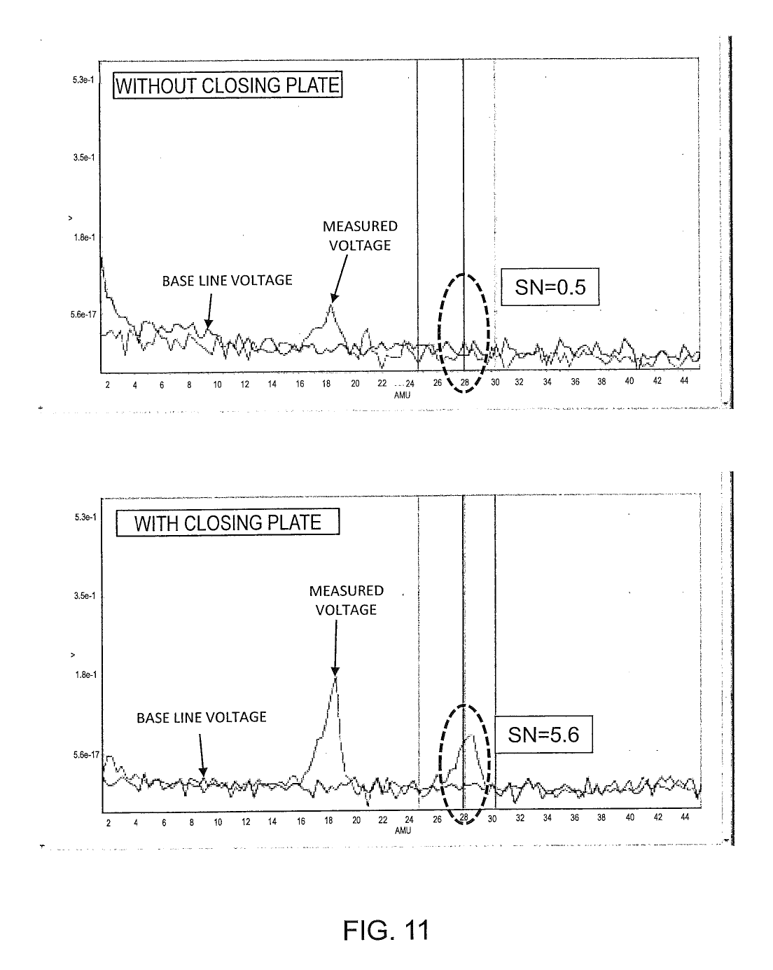

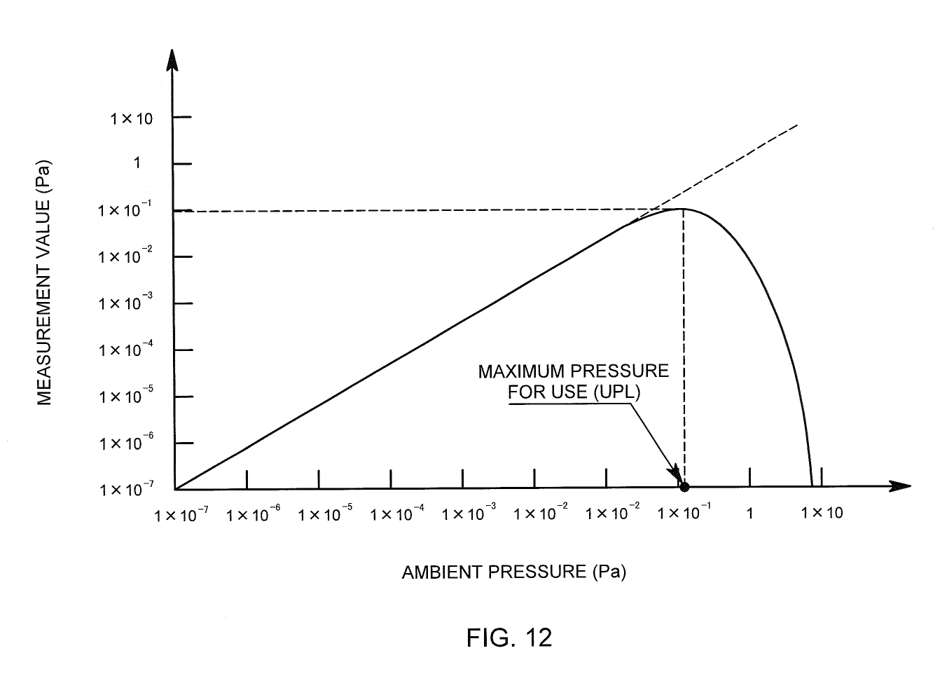

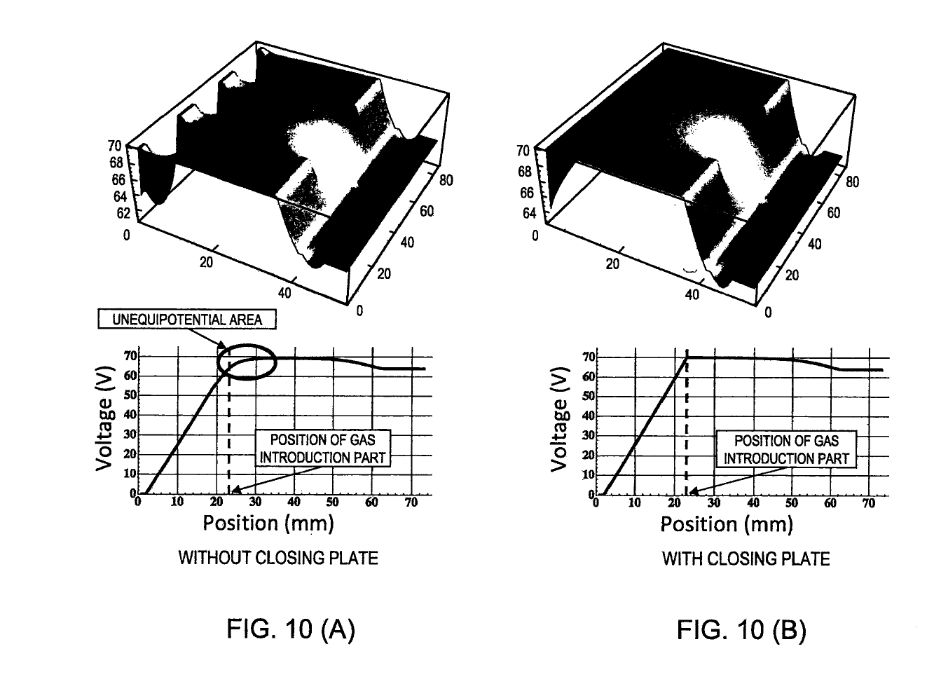

Next, an effect of the unequipotential reducing structure 216 will be explained with reference to FIG. 10. FIG. 10(A) is a view (upper part) to show an equipotential surface in the ionizing part 211 in case of having no unequipotential reducing structure 216 and a view (lower part) to show an electric potential in the casing of the ionizing part 211. FIG. 10(B) is a view (upper part) to show an equipotential surface in the ionizing part 211 in case of having the unequipotential reducing structure 216 and a view (lower part) to show an electric potential in the casing of the ionizing part 211. The position 0 mm in FIG. 10 is a position of the protection cover 215 as being the ground electric potential. In addition, 70V is applied to the casing of the ionizing part 211, and 64V is applied to the ion drawing electrode 212 and the pole electrodes 213P of the quadrupole part 213. From FIG. 10(A), it becomes clear that the unequipotential area is formed near the gas introduction part 211B (around 22 mm in the lower part view of FIG. 10(A)). Meanwhile, from FIG. 10(B), it becomes clear that an area from the position of the gas introducing part 211 to the inside of the casing is equipotential.

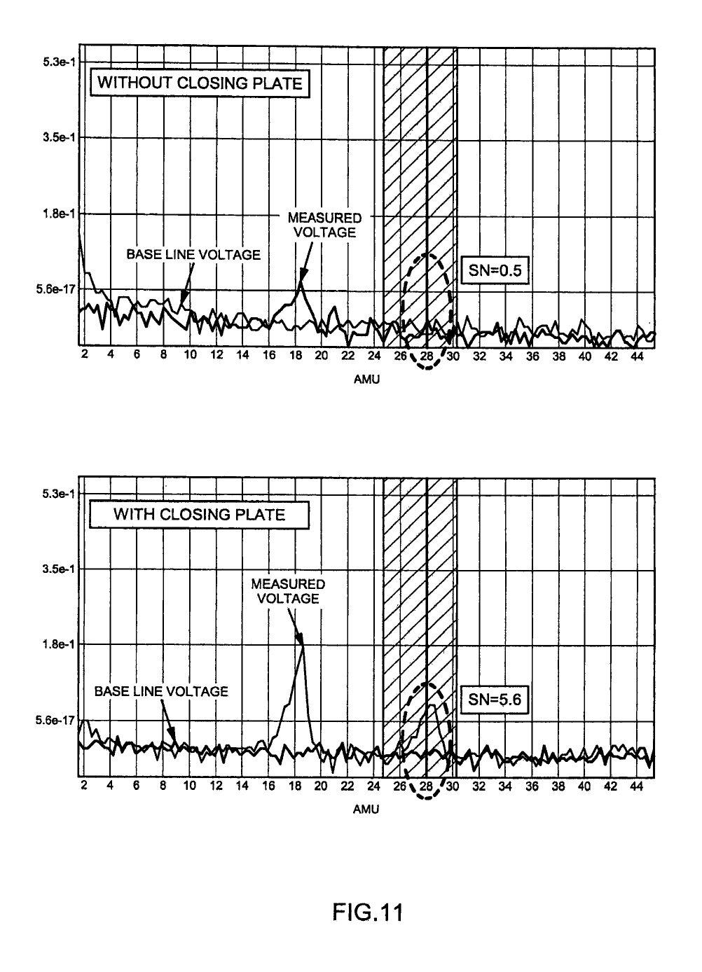

A comparison of an SN ratio between with and without the unequipotential reducing structure 216 is shown in FIG. 11. As shown in FIG. 11, in case of no unequipotential reducing structure 216, the SN ratio is 0.5, while in case of having the unequipotential reducing structure 216, the SN ratio is improved to 5.6.

<Effect of this Embodiment>

In accordance with the gas analyzer 100 of this embodiment, the amount of the ions introduced into the quadrupole part 213 is reduced by setting the opening size of the ion lead-out opening 211A to be smaller than the imaginary inscribing circle (IC) inscribed on all of four pole electrodes 213P constituting the quadrupole part 213 so that the signal value obtained by the ion detecting part 214 becomes small. As a result of this, it is possible to high-pressurize the maximum pressure for use. Concretely, the maximum pressure for use can be raised to a low vacuum area (for example, 1.3 Pa). In addition, since the opening size of the ion lead-out opening 211A is smaller than the imaginary inscribing circle (IC), the ions coming out from the ion lead-out opening 211A can be easily introduced into the quadrupole part 213. Then even though the ion amount itself coming from the ion lead-out opening 211A decreases, it is possible to effectively make use of the ions. Furthermore, since the ionizing part 211, the ion drawing electrode 212, the quadrupole part 213 and the ion detecting part 214 are arranged so as to be exposed to the ambient pressure in the vacuum chamber (VC), there is no need of a differential exhaust mechanism so that it is possible to make the gas analyzer 100 compact.

### Other Modified Embodiment

The present claimed invention is not limited to the above-mentioned embodiment.

For example, the quadrupole part comprises four pole electrodes in the above-mentioned embodiment, however, 16 pole electrodes may be arranged in a matrix in a plane four by four and nine quadrupole parts are formed. In this case, an ion lead-out opening and an opening of an ion drawing electrode are formed to correspond to each of the nine quadrupole parts respectively.

In addition, the unequipotential reducing structure of the above-mentioned embodiment is not limited to the closing plate, and may comprise a gas introduction part whose diameter is formed so small as to substantially ignore an influence of the unequipotential on the ion detecting signal (ionic current).

It is a matter of course that the present claimed invention is not limited to the above-mentioned embodiment and may be variously modified without departing from a spirit of the invention.

### EXPLANATION OF CODES

100 . . . gas analyzer
211 . . . ionizing part
211A . . . ion lead-out part
211B . . . gas introducing part
212 . . . ion drawing electrode
212H . . . opening part
213 . . . quadrupole part
213P . . . pole electrode
IC . . . imaginary inscribing circle
214 . . . ion detecting part
215 . . . protection cover (peripheral member)
216 . . . unequipotential reducing structure

1. A gas analyzer that is mounted on a vacuum chamber and that analyzes a sample gas in the vacuum chamber, and comprising
an ionizing part that ionizes the sample gas and that has an ion lead-out opening to lead out ions to the outside,
an ion drawing electrode that is arranged outside of the ion lead-out opening of the ionizing part and that derives the ions,
a quadrupole part that selectively passes the ions lead out from the ionizing part by the ion drawing electrode, and
an ion detecting part that detects the ions passing the quadrupole part, wherein
the ionizing part, the ion drawing electrode, the quadrupole part and the ion detecting part are arranged so as to be exposed to an ambient pressure in the vacuum chamber, and
an opening size of the ion lead-out opening is set to be smaller than an imaginary circle inscribed on all of four pole electrodes constituting the quadrupole part in order to raise the maximum pressure for use showing the ambient pressure where a signal value obtained by the ion detecting part becomes a peak value.

2. The gas analyzer described in claim 1, wherein
the ion drawing electrode has an opening part through which the ions pass, and an opening size of the opening part is set to be smaller than an opening size of the ion lead-out opening in order to reduce a quantity of electrons emitted from the ionizing part.

3. The gas analyzer described in claim 1, wherein
the ionizing part has an unequipotential reducing structure that reduces an unequipotential area generating near a gas introducing part of the ionizing part by means of a peripheral member of a ground potential arranged outside of the ionizing part.
